(19) United States
(12) Patent Application Publication
(10) Pub. No.: US 2006/0285542 A1
(43) Pub. Date: Dec. 21, 2006

(54) Method and system for automatically providing and adjusting optical channel concatenation

(75) Inventors: Linda Dunbar, Plano, TX (US); Harbhajan Virdee, Richardson, TX (US); John A. McLaughlin III, McKinney, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 11/296,660

(22) Filed: Dec. 6, 2005

Related U.S. Application Data
(60) Provisional application No. 60/692,533, filed on Jun. 20, 2005.

(51) Int. Cl. H04L 12/56

(52) U.S. Cl. 370/395.51

(57) ABSTRACT

A method and system for providing channel concatenations. The method includes generating a plurality of STSm's associated with a plurality of network nodes. m is a positive integer, and the plurality of STSm's is allocated for linking a first device and a second device through the plurality of network nodes. Additionally, the method includes setting the plurality of STSm's to a first plurality of states related to the plurality of network nodes. The plurality of network nodes includes a first node and a second node. Moreover, the method includes determining whether a first valid signal is received from the first device by the first node, the first valid signal including information associated with a concatenation.

### CROSS-REFERENCES TO RELATED APPLICATIONS

This application claims priority to U.S. Provisional Application No. 60/692,533 filed Jun. 20, 2005, which is incorporated by reference herein.

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

The present invention relates in general to telecommunication techniques. More particularly, the invention provides a method and system for automatically providing and adjusting optical channel concatenation. Merely by way of example, the invention is described as it applies to Synchronous Optical Network (SONET) and Synchronous Digital Hierarchy (SDH), but it should be recognized that the invention has a broader range of applicability.

Telecommunication techniques have progressed through the years. As merely an example, Synchronous Optical Network (SONET) and Synchronous Digital Hierarchy (SDH) have been used for conventional optical telecommunications for telephone applications. Each of the SONET and the SDH defines a technique for transmitting multiple signals of different capacities through a synchronous, flexible, optical hierarchy. The SONET and the SDH each can terminate signals, multiplex signals from a lower speed to a higher speed, switch signals, and transport signals in the network according to certain definitions.

The optical channels in SONET or SDH can be concatenated to create a logical channel. The logic channel often has a line rate that is significantly higher than ones for individual optical channels. The channel concatenation usually is manually provisioned and often cannot be automatically changed in response to payload adjustment. For example, when a service provider sells to its client certain optical circuits of OC-n or STM-n, the channel concatenation for client payload often has to be pre-determined and pre-provisioned. When the client needs to change channel concatenation, the client usually has to notify the service provider. In response, the service provider manually changes the channel concatenation so that the client can use the newly provisioned channel concatenation for its payload. The manual provisioning and adjustment of payload concatenation often takes a lengthy period of time.

Hence it is highly desirable to improve techniques for providing and adjusting optical channel concatenation.

### BRIEF SUMMARY OF THE INVENTION

The present invention relates in general to telecommunication techniques. More particularly, the invention provides a method and system for automatically providing and adjusting optical channel concatenation. Merely by way of example, the invention is described as it applies to Synchronous Optical Network (SONET) and Synchronous Digital Hierarchy (SDH), but it should be recognized that the invention has a broader range of applicability.

According to one embodiment of the present invention, a method for providing channel concatenations includes generating a plurality of STSm's associated with a plurality of network nodes. m is a positive integer, and the plurality of STSm's is allocated for linking a first device and a second device through the plurality of network nodes. Additionally, the method includes setting the plurality of STSm's to a first plurality of states related to the plurality of network nodes. The plurality of network nodes includes a first node and a second node. Moreover, the method includes determining whether a first valid signal is received from the first device by the first node, the first valid signal including information associated with a concatenation. Also, the method includes if the first valid signal is received from the first device by the first node, processing information associated with the concatenation, and providing a first uni-directional cross-connect in a first direction associated with the first node based on at least information associated with the concatenation. The providing a first uni-directional cross-connect includes providing the concatenation to the plurality of STSm's in the first direction.

According to another embodiment, a method for providing channel concatenations includes generating a plurality of STSm's associated with a plurality of network nodes. m is a positive integer, and the plurality of STSm's is allocated for linking a first device and a second device through the plurality of network nodes. Additionally, the method includes setting the plurality of STSm's to a first plurality of states related to the plurality of network nodes. The plurality of network nodes includes a first node and a second node. Moreover, the method includes determining whether a first valid signal is received from the first device by the first node. The first valid signal includes information associated with a concatenation. Also, the method includes if the first valid signal is received from the first device by the first node, determining whether the information associated with the concatenation is valid, and if the information associated with the concatenation is determined to be valid, providing a first uni-directional cross-connect in a first direction associated with the first node based on at least information associated with the concatenation. The providing a first uni-directional cross-connect includes providing the concatenation to the plurality of STSm's in the first direction.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving information associated with a second concatenation from the first device by a first node of the plurality of network nodes, processing information associated with the second concatenation, and providing a first unidirectional cross-connect in the first direction associated with the first node based on at least information associated with the second concatenation. The providing a first uni-directional cross-connect includes providing the second concatenation to the plurality of STSm's in the first direction.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving information associated with a second concatenation from the first device by a first node of the plurality of network nodes, and determining whether the information associated with the second concatenation is valid. Moreover, the method includes if the information associated with the second concatenation is determined to be valid, providing a first uni-directional cross-connect in the first direction associated with the first node based on at least information associated with the second concatenation. The providing a first uni-directional cross-connect includes providing the second concatenation to the plurality of STSm's in the first direction.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving first information associated with a second concatenation from the first device by a first node of the plurality of network nodes, and receiving second information associated with the second concatenation from the second device by a second node of the plurality of network nodes. Moreover, the method includes processing the first information associated with the second concatenation, and processing the second information associated with the second concatenation. Also, the method includes providing a first uni-directional cross-connect in the first direction associated with the first node based on at least information associated with the second concatenation, and providing a second uni-directional cross-connect in the second direction associated with the second node based on at least information associated with the second concatenation. The providing a first uni-directional cross-connect includes providing the second concatenation to the plurality of STSm's in the first direction, and the providing a second uni-directional cross-connect includes providing the second concatenation to the plurality of STSm's in the second direction.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving first information associated with a second concatenation from the first device by a first node of the plurality of network nodes, and receiving second information associated with the second concatenation from the second device by a second node of the plurality of network nodes. Moreover, the method includes determining whether the first information associated with the second concatenation is valid, and determining whether the second information associated with the second concatenation is valid. Also, the method includes if the first information associated with the second concatenation is determined to be valid, providing a first uni-directional cross-connect in the first direction associated with the first node based on at least information associated with the second concatenation. Additionally, the method includes if the second information associated with the second concatenation is determined to be valid, providing a second uni-directional cross-connect in the second direction associated with the second node based on at least information associated with the second concatenation. The providing a first uni-directional cross-connect includes providing the second concatenation to the plurality of STSm's in the first direction, and the providing a second uni-directional cross-connect includes providing the second concatenation to the plurality of STSm's in the second direction.

Many benefits are achieved by way of the present invention over conventional techniques. Some embodiments of the present invention provide a mechanism that can automate the process of changing payload concatenation. For example, when clients need to change payload concatenation, the service provider no longer needs to manually change the configuration and then notify the clients. In another example, the service provider can sell an OC-n circuit, such as an OC-12 circuit, to a client, such as an end user, who can decide what signal type to use. For example, the signal type is STS12c, STS3c, STS1, or any combination of them. Certain embodiments of the present invention provide a mechanism that utilizes the SONET/SDH payload pointer H1/H2/H3 bytes as indicator for payload concatenation change, and take intelligent actions on the nodes within a service provider's network. Some embodiments of the present invention can eliminate or reduce manual notification from a client to its service provider about a pre-defined circuit signal type. For example, the adaptation process for optical circuit payload concatenation is automated. In another example, a service provider can offer optical circuits such as OC-n or STM-n without being concerned about its clients' payload concatenations. Certain embodiments of the present invention can eliminate or reduce the manual process of clients notifying their service provider when the clients need to change optical channel payload concatenations. Some embodiments of the present invention can monitor individual paths or components of a bundle of STSm's or VCm's. Certain embodiments of the present invention can provide summary alarms for a bundle of STSm's or VCm's. Some embodiments of the present invention are compliant with GR-1093 State Model.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram for conventional optical network;

FIG. 2 is a simplified method for providing channel concatenation according to an embodiment of the present invention;

FIG. 3 is a simplified diagram for an optical network with STSm-nB according to an embodiment of the present invention;

FIG. 4 is a simplified diagram for establishing uni-directional cross-connect with STSm-nB according to an embodiment of the present invention;

FIG. 5 is a simplified diagram for establishing uni-directional cross-connect in first direction and second direction with STSm-nB according to an embodiment of the present invention;

FIG. 6 is a simplified method for modifying channel concatenation according to an embodiment of the present invention;

FIG. 7 is a simplified diagram for modifying unidirectional cross-connect with STSm-nB according to an embodiment of the present invention;

FIG. 8 is a simplified method for modifying channel concatenation according to another embodiment of the present invention;

FIG. 9 is a simplified diagram for modifying unidirectional cross-connect with STSm-nB according to another embodiment of the present invention.

### DETAILED DESCRIPTION OF THE INVENTION

The present invention relates in general to telecommunication techniques. More particularly, the invention provides a method and system for automatically providing and adjusting optical channel concatenation. Merely by way of example, the invention is described as it applies to Synchronous Optical Network (SONET) and Synchronous Digital Hierarchy (SDH), but it should be recognized that the invention has a broader range of applicability.

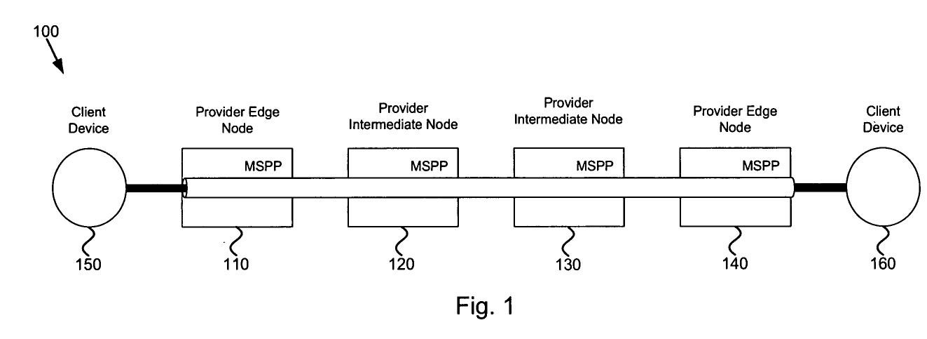

FIG. 1 is a simplified diagram for conventional optical network. The network 100 includes network nodes 110, 120, 130, and 140. Each of these nodes is provided with a Multiservice Provisioning Platform (MSPP). Through the nodes 110, 120, 130, and 140, client devices 150 and 160 can communicate with each other over an optical path. For example, the nodes 110 and 140 are directly connected to the client devices 150 and 160 respectively, and called provider edge nodes. In another example, the nodes 120 and 130 are located on the optical path but not directly connected to either the client device 150 or the client device 160. The nodes 120 and 130 are called provider intermediate nodes. In yet another example, the client devices 150 and 160 are connected or not connected to the optical path.

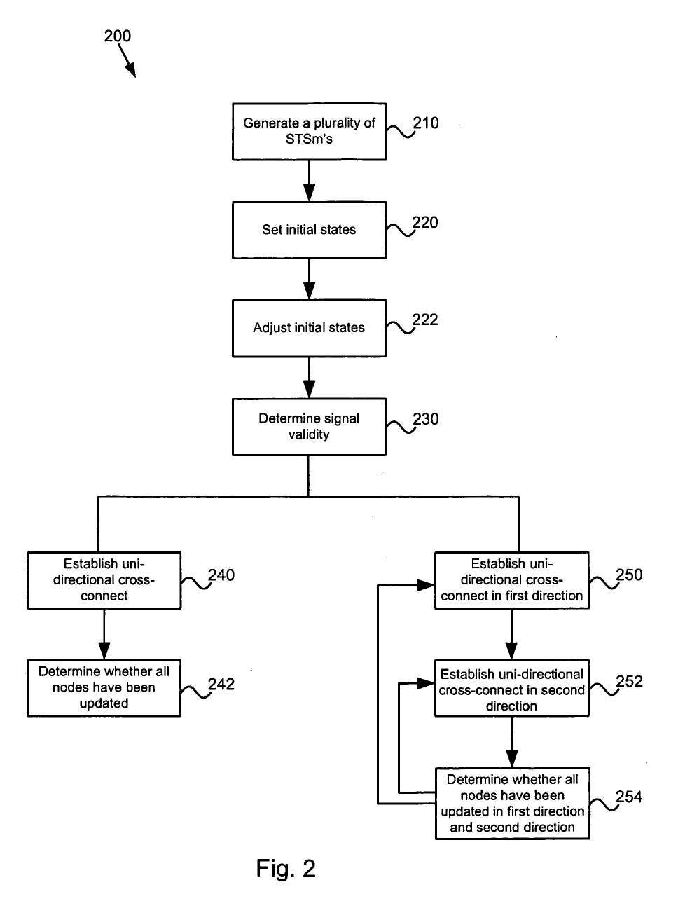

FIG. 2 is a simplified method for providing channel concatenation according to an embodiment of the present invention. This diagram is merely an example, which should not unduly limit the scope of the claims. One of ordinary skill in the art would recognize many variations, alternatives, and modifications. The method 200 includes a process 210 for generating a plurality of STSm's, a process 220 for setting initial states, a process 222 for adjusting initial states, a process 230 for determining signal validity, a process 240 for establishing uni-directional cross-connect, a process 242 for determining whether all nodes have been updated, a process 250 for establishing uni-directional cross-connect in first direction, a process 252 for establishing uni-directional cross-connect in second direction, and a process 254 for determining whether all nodes have been updated in first direction and second direction. Although the above has been shown using a selected sequence of processes, there can be many alternatives, modifications, and variations. For example, some of the processes may be expanded and/or combined. In one embodiment, the process 220 for setting initial states and the process 222 for adjusting initial states are combined into one process for setting the plurality of STSm's to a plurality of states. Other processes may be inserted to those noted above. Depending upon the embodiment, the specific sequence of processes may be interchanged with others replaced. For example, the process 252 is performed prior to the process 250. In another example, the processes 250 and 252 are performed simultaneously. Some of the processes may be expanded and/or combined, and/or other processes may be inserted to those noted above. For example, at least one of the processes 250 and 252 is skipped. In another example, the method 800 is used to modify concatenation of STSm-nB on one or more network nodes. Further details of these processes are found throughout the present specification and more particularly below.

At the process 210, a plurality of STSm's is generated, and m is a positive integer. For example, m is equal to 1, 3, 12, 48, 192, or 768. In one embodiment, the plurality of STSm's is contiguous and bundled into an STSm-nB. n represents the number of STSm's for the plurality of STSm's. For example, the plurality of STSm's is designated for linking two client devices. In anther example, the plurality of STSm's is not concatenated upon creation. These STSm's can be concatenated later, and their concatenations can also be modified. In yet another example, an STSm-nB is created on all network nodes for an optical path that can be used for linking two client devices.

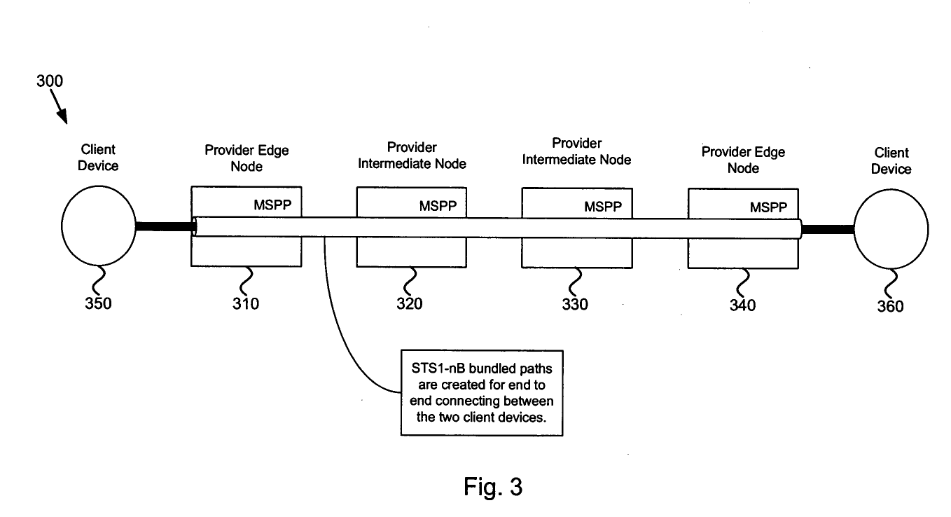

FIG. 3 is a simplified diagram for an optical network with STSm-nB according to an embodiment of the present invention. This diagram is merely an example, which should not unduly limit the scope of the claims. One of ordinary skill in the art would recognize many variations, alternatives, and modifications. The network 300 includes network nodes 310, 320, 330, and 340. For example, the network 300 is a SONET network. In another example, each of these nodes is provided with a Multiservice Provisioning Platform (MSPP). Through the nodes 310, 320, 330, and 340, client devices 350 and 360 can communicate with each other over an optical path. For example, the nodes 310 and 340 are directly connected to the client devices 350 and 360 respectively, and called provider edge nodes. In another example, the nodes 320 and 330 are located on the optical path but not directly connected to either the client device 350 or the client device 360. The nodes 320 and 330 are called provider intermediate nodes. In yet another example, the client devices 350 and 360 are connected or not connected to the optical path.

An STSm-nB is created on all of the network nodes 310, 320, 330, and 340. For example, if an OC-n circuit is to be sold to an client as the client device 350 or 360, n contiguous STS 1's are generated to form an STS 1-nB. In one embodiment, n is equal to 3, 12, 48, 192, or 768. In another embodiment, 12 contiguous STS1's form an STS1-12B, which can be later set to various concatenations such as STS1, STS3c, or STS12c.

At the process 220, the STSm-nB is set to initial states. In one embodiment, the initial state is Auto-InService at each provider intermediate node. For example, Auto-InService is OOS-AU, AINS according to GR-1093. In another embodiment, the initial state is OOS-MA, MT at each provider edge node. Under OOS-MA, MT, the STSm-nB is manually removed from service for maintenance. In yet another embodiment, the process 220 is performed before the corresponding OC-n circuit is sold to an client as the client device 350 or 360.

In one embodiment, under either OOS-AU, AINS or OOS-MA, MT, conditions for each STSm of the STSm-nB continue to be monitored and accumulated, but there is no autonomous reporting of conditions. For example, the conditions include pulse modulation (PM) statistics. In another example, the conditions can be manually retrieved by the user. In yet another example, if any condition exists, even though non-alarmed or non-reported under OOS-AU, AINS, the STSm-nB on a network node does not transition from Auto-InService to the In-Service state.

In another embodiment, under either Out Of Service—Autonomous (OOS-AU), AutomaticInService (AINS) or Out-of-Service-Management (OOS-MA), Maintenance (MT), the Alarm Indication Signal—Path (AIS-P) codes are sent along each STSm path of the STSm-nB. The AIS-P codes can instruct the provider intermediate nodes not to report unequipped for intermediate path (UNEQ-P) alarms. For example, the optical path linking two client devices appears normal to all the provider intermediate nodes.

At the process 222, initial state of the STSm-nB is adjusted. Upon adjustment, the initial state is Auto-InService at each network node, regardless of whether the node is a provider intermediate node or a provider edge node. For example, the provider edge nodes are restored out of the maintenance state by a user command. In one embodiment, the process 220 is performed after the corresponding OC-n circuit is sold to an client as the client device 350 or 360.

At the process 230, signal validity is determined. In one embodiment, a valid signal is not detected if a client device is not connected to the corresponding provider edge node. For example, if a client device is not connected to the corresponding provider edge node, loss of signal (LOS) is detected by the provider edge node. LOS is a non-alarmed or non-reported condition under Auto-InService. In another embodiment, a valid signal is not detected if a proper optical interface is not provisioned or the concatenation on the interface is not provisioned by the client device. In response, an UNEQ-P indication is received by the corresponding provider edge node.

If a valid signal is received by only one provider edge node from the corresponding client device, the processes 240 and 242 are preformed. For example, if a valid signal is received by the provider edge node 310 from the client device 350 but a valid signal is not received by the provider edge node 340 from the client device 360, the processes 240 and 242 are preformed. If a valid signal is received by each of the two provider edge nodes from the corresponding client device, the processes 250, 252, and 254 are performed. For example, if a valid signal is received by the provider edge node 310 from the client device 350 and a valid signal is received by the provider edge node 340 from the client device 360, the processes 250, 252, and 254 are performed.

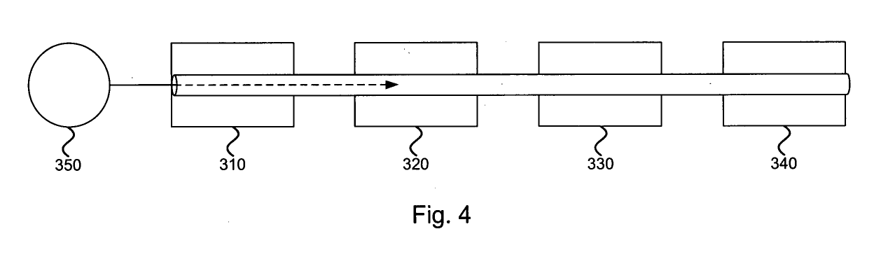

At the process 240, a uni-directional cross-connect is established on a network node. FIG. 4 is a simplified diagram for establishing uni-directional cross-connect with STSm-nB according to an embodiment of the present invention. This diagram is merely an example, which should not unduly limit the scope of the claims. One of ordinary skill in the art would recognize many variations, alternatives, and modifications.

In one embodiment, the network node is a provider edge node that receives a valid signal from the corresponding client device. For example, the network node is the node 310, which receives a valid signal from the client device 350. The provider edge node detects disappearance of the UNEQ-P indication or the LOS indication, and receives the STS concatenation information from the corresponding client device. For example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations is the same. For example, the plurality of frames includes 5 frame. If the plurality of concatenations is the same, the concatenation is determined to be valid. If the concatenation is valid, the provider edge node stops sending the Alarm Indication Signal (AIS) signal. Additionally, the provider edge node establishes a uni-directional cross-connect and sends the concatenation information to the next node. For example, the proper concatenation for STSm-nB is established on the provider edge node in one direction. In another example, the node 310 establishes a uni-directional cross-connect and sends the concatenation information to the node 320.

In another embodiment, the network node is a provider intermediate node that receives the concatenation information from another network node. For example, the provider intermediate node is the node 320, which receives the concatenation information from the node 310. In another example, the proper STS concatenation is indicated by the H1/H2/H3 payload pointers. In one embodiment, the provider intermediate node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider intermediate node establishes a uni-directional cross-connect and sends the concatenation information to the next node. For example, the proper concatenation for STSm-nB is established on the provider intermediate node in one direction. In another example, the node 320 establishes a uni-directional cross-connect and sends the concatenation information to the node 330.

In yet another embodiment, the network node is a provider edge node that receives the concatenation information from another network node. For example, the provider edge node is the node 340, which receives the concatenation information from the node 330. In another example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider edge node establishes a uni-directional cross-connect. For example, the proper concatenation for STSm-nB is established on the provider edge node in one direction. In another example, the node 340 establishes a uni-directional cross-connect pointing away the network.

At the process 242, it is determined whether all nodes on an optical path have been updated. If the process 240 has not been performed for all network nodes on the optical path, the process 240 is performed for a network node that has received the concatenation information from another network node but have not yet been updated through the process 240. If the process 240 has been performed for all network nodes on the optical path, a one-way cross-connect is established on all the network nodes. All the network nodes are still under Auto-InService, and the provider edge node that do not directly receive a valid signal from the corresponding client device still sends an AIS signal towards the network.

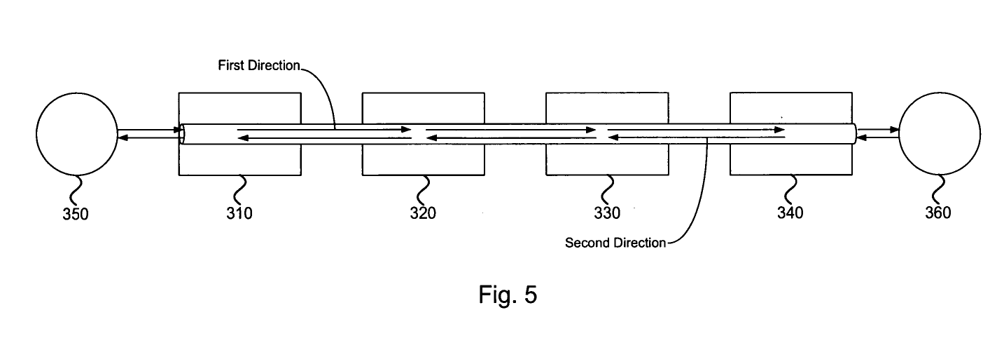

At the process 250, a uni-directional cross-connect is established in a first direction on a network node. FIG. 5 is a simplified diagram for establishing uni-directional cross-connect in first direction and second direction with STSm-nB according to an embodiment of the present invention. This diagram is merely an example, which should not unduly limit the scope of the claims. One of ordinary skill in the art would recognize many variations, alternatives, and modifications.

In one embodiment, the network node is a provider edge node that receives a valid signal from the corresponding client device. For example, the network node is the node 310, which receives a valid signal from the client device 350. The provider edge node detects disappearance of the UNEQ-P indication or the LOS indication, and receives the STS concatenation information from the corresponding client device. For example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider edge node stops sending the AIS signal. Additionally, the provider edge node establishes a uni-directional cross-connect in the first direction and sends the concatenation information to the next node. For example, the proper concatenation for STSm-nB is established on the provider edge node in the first direction. In another example, the node 310 establishes a uni-directional cross-connect and sends the concatenation information to the node 320.

In another embodiment, the network node is a provider intermediate node that receives the concatenation information from another network node. For example, the provider intermediate node is the node 320, which receives the concatenation information from the node 310. In another example, the proper STS concatenation is indicated by the H1/H2/H3 payload pointers. In one embodiment, the provider intermediate node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider intermediate node establishes a uni-directional cross-connect in the first direction and sends the concatenation information to the next node. For example, the proper concatenation for STSm-nB is established on the provider intermediate node in the first direction. In another example, the node 320 establishes a uni-directional cross-connect and sends the concatenation information to the node 330.

In yet another embodiment, the network node is a provider edge node that receives the concatenation information from another network node. For example, the provider edge node is the node 340, which receives the concatenation information from the node 330. In another example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider edge node establishes a unidirectional cross-connect in the first direction. For example, the proper concatenation for STSm-nB is established on the provider edge node in one direction. In another example, the node 340 establishes a uni-directional cross-connect pointing to the client device 360.

At the process 252, a uni-directional cross-connect is established in a second direction on a network node. As discussed above, FIG. 5 is a simplified diagram for establishing uni-directional cross-connect in first direction and second direction with STSm-nB according to an embodiment of the present invention. For example, the first direction and the second direction are different.

In one embodiment, the network node is a provider edge node that receives a valid signal from the corresponding client device. For example, the network node is the node 340, which receives a valid signal from the client device 360. The provider edge node detects disappearance of the UNEQ-P indication or the LOS indication, and receives the STS concatenation information from the corresponding client device. For example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider edge node stops sending the AIS signal. Additionally, the provider edge node establishes a uni-directional cross-connect in the second direction and sends the concatenation information to the next node. For example, the proper concatenation for STSm-nB is established on the provider edge node in the second direction. In another example, the node 340 establishes a unidirectional cross-connect and sends the concatenation information to the node 330.

In another embodiment, the network node is a provider intermediate node that receives the concatenation information from another network node. For example, the provider intermediate node is the node 330, which receives the concatenation information from the node 340. In another example, the proper STS concatenation is indicated by the H1/H2/H3 payload pointers. In one embodiment, the provider intermediate node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider intermediate node establishes a uni-directional cross-connect in the second direction and sends the concatenation information to the next node. For example, the proper concatenation for STSm-nB is established on the provider intermediate node in the second direction. In another example, the node 330 establishes a uni-directional cross-connect and sends the concatenation information to the node 320.

In yet another embodiment, the network node is a provider edge node that receives the concatenation information from another network node. For example, the provider edge node is the node 310, which receives the concatenation information from the node 320. In another example, the proper STS concatenation is indicated by the H1/H2/H3 payload pointers. In one embodiment, the provider edge node receives a plurality of consecutive frames of the valid signal, and determines whether the concatenation for the plurality of frames is consistent. For example, the plurality of consecutive frames includes 5 consecutive frames. If the concatenation is consistent, the concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the concatenation is determined to be valid. If the concatenation is valid, the provider edge node establishes a unidirectional cross-connect in the second direction. For example, the proper concatenation for STSm-nB is established on the provider edge node in the second direction. In another example, the node 310 establishes a uni-directional cross-connect pointing to the client device 350.

At the process 254, it is determined whether all nodes have been updated in the first direction and the second direction. If the process 250 has not been performed for all network nodes on the optical path, the process 250 is performed for a network node that has received the concatenation information from another network node but have not yet been updated through the process 250. If the process 252 has not been performed for all network nodes on the optical path, the process 252 is performed for a network node that has received the concatenation information from another network node but have not yet been updated through the process 252. If an provider edge node is updated by the processes 250 and 252 with the STS concatenation information from both directions, and the STS concatenations from both directions match, the provider edge node switch to Auto-InService to In-Service. In response, the proper payload can pass through.

As discussed above and further emphasized here, FIG. 2 is merely an example, which should not unduly limit the scope of the claims. One of ordinary skill in the art would recognize many variations, alternatives, and modifications. For example, during the processes 250, 252, and 254, if a network node has established the uni-directional cross-connect in only one of the first direction and the second direction, the network node would generate the Auto-InService misconcatenation alarm.

In another example, the method 200 is used for an SDH network. For example, the network 300 is a SDH network. At the process 210, a plurality of VCm's is generated, and m is a positive integer. For example, m is equal to 4. In one embodiment, the plurality of VCm's is contiguous and bundled into an VCm-nB. n represents the number of VCm's for the plurality of VCm's. For example, the plurality of VCm's is designated for linking two client devices. In anther example, the plurality of VCm's is not concatenated upon creation. These VCm's can be concatenated later, and their concatenations can also be modified. In yet another example, an VCm-nB is created on all network nodes for an optical path that can be used for linking two client devices. At the process 220, the VCm-nB is set to initial states. At the process 222, initial states of the VCm-nB is adjusted. At the process 240, 250, and/or 252, a uni-directional cross-connect is established on a network node based on the received VC concatenation information.

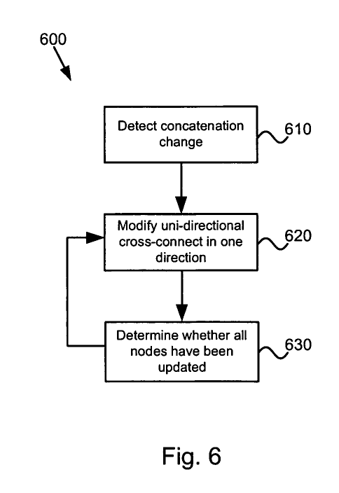

FIG. 6 is a simplified method for modifying channel concatenation according to an embodiment of the present invention. This diagram is merely an example, which should not unduly limit the scope of the claims. One of ordinary skill in the art would recognize many variations, alternatives, and modifications. The method 600 includes a process 610 for detecting concatenation change, a process 620 for modifying uni-directional cross-connect in one direction, and a process 630 for determining whether all nodes have been updated. Although the above has been shown using a selected sequence of processes, there can be many alternatives, modifications, and variations. For example, some of the processes may be expanded and/or combined. Other processes may be inserted to those noted above. Depending upon the embodiment, the specific sequence of processes may be interchanged with others replaced. In another example, the method 600 is used to modify concatenation of STSm-nB on one or more network nodes. Further details of these processes are found throughout the present specification and more particularly below.

At the process 610, a concatenation change is detected. For example, prior to the process 610, all network nodes for linking two client devices have been updated by the method 200 and switched to the In-Service state. In another example, a provider edge node receives an UNEQ indication and/or an LOS indication from the corresponding client device, and then receives information about new STS concatenation. In one embodiment, the new STS concatenation is indicated by the H1/H2/H3 payload pointers.

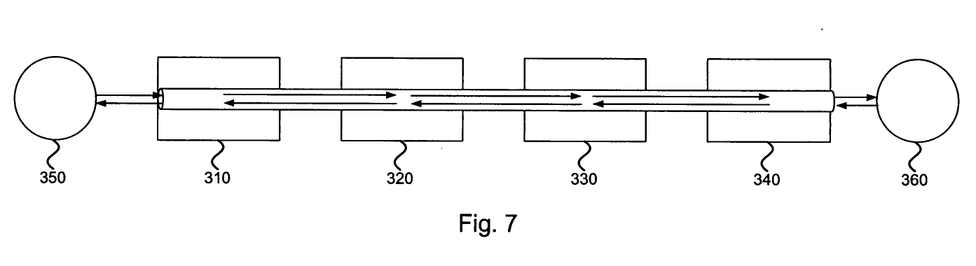

FIG. 7 is a simplified diagram for modifying uni-directional cross-connect with STSm-nB according to an embodiment of the present invention. This diagram is merely an example, which should not unduly limit the scope of the claims. One of ordinary skill in the art would recognize many variations, alternatives, and modifications. Each of the network nodes 310, 320, 330, and 340 has been processed by the method 200 and switched to the In-Service state. For example, the provider edge node 310 receives an UNEQ indication and/or an LOS indication from the client device 350, and then receives information about a new STS concatenation also from the client device 350. In one embodiment, the new STS concatenation is indicated by the H1/H2/H3 payload pointers.

At the process 620, a uni-directional cross-connect is modified on a network node in one direction. In one embodiment, the network node is a provider edge node that receives information about the new STS concatenation from the corresponding client device. For example, the network node is the node 310, which receives information about the new STS concatenation from the client device 350. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the uni-directional cross-connect and sends the new concatenation information to the next node. For example, the new concatenation for STSm-nB is established on the provider edge node in one direction. In another example, the node 310 modifies a uni-directional cross-connect and sends the concatenation information to the node 320.

In another embodiment, the network node is a provider intermediate node that receives information about the new STS concatenation from another network node. For example, the provider intermediate node is the node 320, which receives information about the new STS concatenation from the node 310. In another example, the proper STS concatenation is indicated by the H1/H2/H3 payload pointers. In one embodiment, the provider intermediate node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider intermediate node modifies the uni-directional cross-connect and sends the new concatenation information to the next node. For example, the new concatenation for STSm-nB is established on the provider intermediate node in one direction. In another example, the node 320 modifies the uni-directional cross-connect and sends the concatenation information to the node 330.

In yet another embodiment, the network node is a provider edge node that receives information about the new STS concatenation from another network node. For example, the provider edge node is the node 340, which receives information about the new STS concatenation from the node 330. In another example, the proper STS concatenation is indicated by the H1/H2/H3 payload pointers. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the unidirectional cross-connect. For example, the new concatenation for STSm-nB is established on the provider edge node in one direction. In another example, the node 340 modifies the unidirectional cross-connect pointing away the network.

At the process 630, it is determined whether all nodes on an optical path have been updated. For example, if the process 620 has not been performed for all network nodes on the optical path, the process 620 is performed for a network node that has received the new concatenation information from another network node but has not yet been updated through the process 620. In another example, the uni-directional cross-connect is modified in only one direction for a network node, and the concatenations for the network node in two directions do not match. In response the network node generates the concatenation mismatch alarm.

As discussed above and further emphasized here, FIG. 6 is merely an example, which should not unduly limit the scope of the claims. One of ordinary skill in the art would recognize many variations, alternatives, and modifications. For example, the method 600 is used to modify concatenation of VCm-nB on one or more network nodes in an SDH network. In another example, the network 300 is an SDH network. At the process 610, a concatenation change is detected. For example, prior to the process 610, all network nodes for linking two client devices have been updated by the method 200 and switched to the In-Service state. In another example, a provider edge node receives an UNEQ indication and/or an LOS indication from the corresponding client device, and then receives information about new VC concatenation. In one embodiment, the new VC concatenation is indicated by the H1/H2/H3 payload pointers. At the process 620, unidirectional cross-connect is modified on a network node in one direction based on the received VC concatenation information.

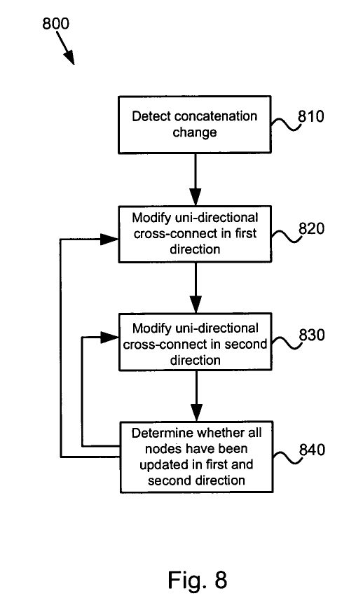

FIG. 8 is a simplified method for modifying channel concatenation according to another embodiment of the present invention. This diagram is merely an example, which should not unduly limit the scope of the claims. One of ordinary skill in the art would recognize many variations, alternatives, and modifications. The method 800 includes a process 810 for detecting concatenation change, a process 820 for modifying uni-directional cross-connect in first direction, a process 830 for modifying uni-directional cross-connect in second direction, and a process 840 for determining whether all nodes have been updated in first direction and second direction. Although the above has been shown using a selected sequence of processes, there can be many alternatives, modifications, and variations. For example, the process 830 is performed prior to the process 820. In another example, the processes 820 and 830 are performed simultaneously. Some of the processes may be expanded and/or combined, and/or other processes may be inserted to those noted above. In one embodiment, at least one of the processes 820 and 830 is skipped. In another embodiment, the method 800 is used to modify concatenation of STSm-nB on one or more network nodes. Further details of these processes are found throughout the present specification and more particularly below.

At the process 810, concatenation changes are detected. For example, prior to the process 810, all network nodes for linking two client devices have been updated by the method 200 and switched to the In-Service state. In another example, a first provider edge node receives an UNEQ indication and/or an LOS indication, and information about new STS concatenation from a corresponding client device. A second provider edge node receives an UNEQ indication and/or an LOS indication, and information about new STS concatenation from another corresponding client device. In one embodiment, the new STS concatenation is indicated by the H1/H2/H3 payload pointers.

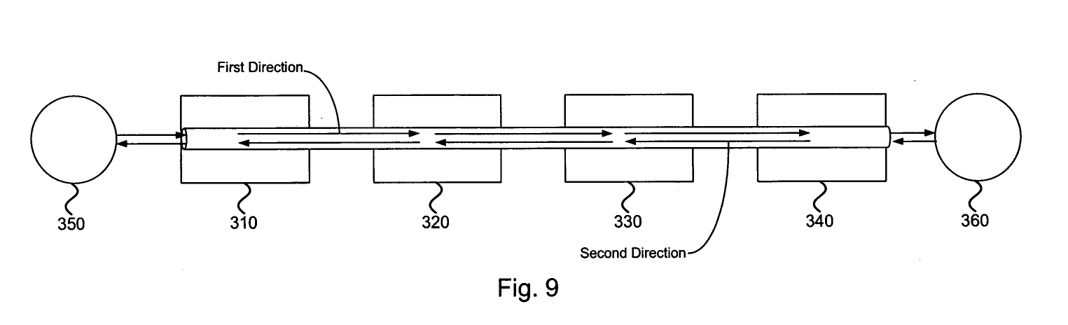

FIG. 9 is a simplified diagram for modifying uni-directional cross-connect with STSm-nB according to another embodiment of the present invention. This diagram is merely an example, which should not unduly limit the scope of the claims. One of ordinary skill in the art would recognize many variations, alternatives, and modifications. Each of the network nodes 310, 320, 330, and 340 has been processed by the method 200 and switched to the In-Service state. For example, the provider edge node 310 receives an UNEQ indication and/or an LOS indication from the client device 350, and then receives information about a new STS concatenation also from the client device 350. The provider edge node 340 receives an UNEQ indication and/or an LOS indication from the client device 360, and then receives information about a new STS concatenation also from the client device 360. In one embodiment, the new STS concatenation is indicated by the H1/H2/H3 payload pointers.

At the process 820, a unidirectional cross-connect is modified on a network node in a first direction. In one embodiment, the network node is a provider edge node that receives information about the new STS concatenation from the corresponding client device. For example, the network node is the node 310, which receives information about the new STS concatenation from the client device 350. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the unidirectional cross-connect in the first direction and sends the new concatenation information to the next node. For example, the new concatenation for STSm-nB is established on the provider edge node in the first direction. In another example, the node 310 modifies a uni-directional cross-connect in the first direction and sends the concatenation information to the node 320.

In another embodiment, the network node is a provider intermediate node that receives information about the new STS concatenation from another network node. For example, the provider intermediate node is the node 320, which receives information about the new STS concatenation from the node 310. In another example, the proper STS concatenation is indicated by the H1/H2/H3 payload pointers. In one embodiment, the provider intermediate node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider intermediate node modifies the uni-directional cross-connect in the first direction and sends the new concatenation information to the next node. For example, the new concatenation for STSm-nB is established on the provider intermediate node in the first direction. In another example, the node 320 modifies the uni-directional cross-connect in the first direction and sends the concatenation information to the node 330.

In yet another embodiment, the network node is a provider edge node that receives information about the new STS concatenation from another network node. For example, the provider edge node is the node 340, which receives information about the new STS concatenation from the node 330. In another example, the proper STS concatenation is indicated by the H1/H2/H3 payload pointers. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the uni-directional cross-connect in the first direction. For example, the new concatenation for STSm-nB is established on the provider edge node in the first direction. In another example, the node 340 modifies the uni-directional cross-connect pointing away the network.

At the process 830, a uni-directional cross-connect is modified on a network node in a second direction. For example, the first direction and the second direction are different. In one embodiment, the network node is a provider edge node that receives information about the new STS concatenation from the corresponding client device. For example, the network node is the node 340, which receives information about the new STS concatenation from the client device 360. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the uni-directional cross-connect in the second direction and sends the new concatenation information to the next node. For example, the new concatenation for STSm-nB is established on the provider edge node in the second direction. In another example, the node 340 modifies a uni-directional cross-connect in the second direction and sends the concatenation information to the node 330.

In another embodiment, the network node is a provider intermediate node that receives information about the new STS concatenation from another network node. For example, the provider intermediate node is the node 330, which receives information about the new STS concatenation from the node 340. In another example, the proper STS concatenation is indicated by the H1/H2/H3 payload pointers. In one embodiment, the provider intermediate node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider intermediate node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider intermediate node modifies the uni-directional cross-connect in the second direction and sends the new concatenation information to the next node. For example, the new concatenation for STSm-nB is established on the provider intermediate node in the second direction. In another example, the node 330 modifies the unidirectional cross-connect in the second direction and sends the concatenation information to the node 320.

In yet another embodiment, the network node is a provider edge node that receives information about the new STS concatenation from another network node. For example, the provider edge node is the node 310, which receives information about the new STS concatenation from the node 320. In another example, the proper STS concatenation is indicated by the H1/H2/H3 payload pointers. In one embodiment, the provider edge node receives a plurality of consecutive frames that indicate the new STS concatenation, and determines whether the concatenation for the plurality of frames is consistent. For example, the plurality of consecutive frames includes 5 consecutive frames. If the concatenation is consistent, the new concatenation is determined to be valid. In another embodiment, the provider edge node receives a plurality of consecutive frames associated with a plurality of concatenations, and determines whether the plurality of concatenations are the same. For example, the plurality of frames includes 5 frame. If the plurality of concatenations are the same, the new concatenation is determined to be valid. If the concatenation is valid, the provider edge node modifies the uni-directional cross-connect in the second direction. For example, the new concatenation for STSm-nB is established on the provider edge node in the second direction. In another example, the node 310 modifies the uni-directional cross-connect pointing away the network.

At the process 840, it is determined whether all nodes on an optical path have been updated in the first direction and the second direction. For example, if the process 820 has not been performed for all network nodes on the optical path, the process 820 is performed for a network node that has received the new concatenation information from another network node but has not yet been updated through the process 820. If the process 830 has not been performed for all network nodes on the optical path, the process 830 is performed for a network node that has received the new concatenation information from another network node but has not yet been updated through the process 830. In another example, the uni-directional cross-connect is modified in only one direction for a network node, and the concatenations for the network node in two directions does not match. In response the network node generates the concatenation mismatch alarm. In yet another example, the uni-directional cross-connects are modified in both directions for a network node, and the concatenations for the network node in two directions match. In response the network node switches back from out of service to In-Service, and the proper load passes through.

As discussed above and further emphasized here, FIG. 8 is merely an example, which should not unduly limit the scope of the claims. One of ordinary skill in the art would recognize many variations, alternatives, and modifications. For example, the method 800 is used to modify concatenation of VCm-nB on one or more network nodes in an SDH network. In another example, the network 300 is an SDH network. At the process 810, concatenation changes are detected. For example, prior to the process 810, all network nodes for linking two client devices have been updated by the method 200 and switched to the In-Service state. In another example, a first provider edge node receives an UNEQ indication and/or an LOS indication, and information about new VC concatenation from a corresponding client device. A second provider edge node receives an UNEQ indication and/or an LOS indication, and information about new VC concatenation from another corresponding client device. In one embodiment, the new VC concatenation is indicated by the H1/H2/H3 payload pointers. At the process 820, the uni-directional cross-connects are modified on a network node in the first direction and the second direction based on the received VC concatenation information.

According to another embodiment of the present invention, a method for providing channel concatenations includes generating a plurality of STSm's associated with a plurality of network nodes. m is a positive integer, and the plurality of STSm's is allocated for linking a first device and a second device through the plurality of network nodes. Additionally, the method includes setting the plurality of STSm's to a first plurality of states related to the plurality of network nodes. The plurality of network nodes includes a first node and a second node. Moreover, the method includes determining whether a first valid signal is received from the first device by the first node, the first valid signal including information associated with a concatenation. Also, the method includes if the first valid signal is received from the first device by the first node, processing information associated with the concatenation, and providing a first uni-directional cross-connect in a first direction associated with the first node based on at least information associated with the concatenation. The providing a first uni-directional cross-connect includes providing the concatenation to the plurality of STSm's in the first direction. For example, the method is performed according to the method 200. In another example, VCm's, instead of STSm's, are used in the method.

According to yet another embodiment, a method for providing channel concatenations includes generating a plurality of STSm's associated with a plurality of network nodes. m is a positive integer, and the plurality of STSm's is allocated for linking a first device and a second device through the plurality of network nodes. Additionally, the method includes setting the plurality of STSm's to a first plurality of states related to the plurality of network nodes. The plurality of network nodes includes a first node and a second node. Moreover, the method includes determining whether a first valid signal is received from the first device by the first node. The first valid signal includes information associated with a concatenation. Also, the method includes if the first valid signal is received from the first device by the first node, determining whether the information associated with the concatenation is valid, and if the information associated with the concatenation is determined to be valid, providing a first uni-directional cross-connect in a first direction associated with the first node based on at least information associated with the concatenation. The providing a first uni-directional cross-connect includes providing the concatenation to the plurality of STSm's in the first direction. For example, the method is performed according to the method 200. In another example, VCm's, instead of STSm's, are used in the method.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving information associated with a second concatenation from the first device by a first node of the plurality of network nodes, processing information associated with the second concatenation, and providing a first uni-directional cross-connect in the first direction associated with the first node based on at least information associated with the second concatenation. The providing a first unidirectional cross-connect includes providing the second concatenation to the plurality of STSm's in the first direction. For example, the method is performed according to the method 600. In another example, VCm's, instead of STSm's, are used in the method.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving information associated with a second concatenation from the first device by a first node of the plurality of network nodes, and determining whether the information associated with the second concatenation is valid. Moreover, the method includes if the information associated with the second concatenation is determined to be valid, providing a first uni-directional cross-connect in the first direction associated with the first node based on at least information associated with the second concatenation. The providing a first uni-directional cross-connect includes providing the second concatenation to the plurality of STSm's in the first direction. For example, the method is performed according to the method 600. In another example, VCm's, instead of STSm's, are used in the method.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving first information associated with a second concatenation from the first device by a first node of the plurality of network nodes, and receiving second information associated with the second concatenation from the second device by a second node of the plurality of network nodes. Moreover, the method includes processing the first information associated with the second concatenation, and processing the second information associated with the second concatenation. Also, the method includes providing a first uni-directional cross-connect in the first direction associated with the first node based on at least information associated with the second concatenation, and providing a second uni-directional cross-connect in the second direction associated with the second node based on at least information associated with the second concatenation. The providing a first uni-directional cross-connect includes providing the second concatenation to the plurality of STSm's in the first direction, and the providing a second uni-directional cross-connect includes providing the second concatenation to the plurality of STSm's in the second direction. For example, the method is performed according to the method 800. In another example, VCm's, instead of STSm's, are used in the method.

According to yet another embodiment, a method for updating channel concatenations includes providing a plurality of network nodes associated with a plurality of STSm's. m is a positive integer, and the plurality of STSm's is allocated for linking a first device and a second device through the plurality of network nodes and is concatenated based on at least information associated with a first concatenation for each of the plurality of network nodes in a first direction and a second direction. Additionally, the method includes receiving first information associated with a second concatenation from the first device by a first node of the plurality of network nodes, and receiving second information associated with the second concatenation from the second device by a second node of the plurality of network nodes. Moreover, the method includes determining whether the first information associated with the second concatenation is valid, and determining whether the second information associated with the second concatenation is valid. Also, the method includes if the first information associated with the second concatenation is determined to be valid, providing a first uni-directional cross-connect in the first direction associated with the first node based on at least information associated with the second concatenation. Additionally, the method includes if the second information associated with the second concatenation is determined to be valid, providing a second uni-directional cross-connect in the second direction associated with the second node based on at least information associated with the second concatenation. The providing a first uni-directional cross-connect includes providing the second concatenation to the plurality of STSm's in the first direction, and the providing a second uni-directional cross-connect includes providing the second concatenation to the plurality of STSm's in the second direction. For example, the method is performed according to the method 800. In another example, VCm's, instead of STSm's, are used in the method.

Embodiments of the methods 200, 600, and/or 800 include code that directs a processor to perform the inventive processes as discussed above. Additionally, embodiments of the methods 200, 600, and/or 800 include a computer-readable medium including instructions for performing the inventive processes as discussed above.

The present invention has various advantages. Some embodiments of the present invention provide a mechanism that can automate the process of changing payload concatenation. For example, when clients need to change payload concatenation, the service provider no longer needs to manually change the configuration and then notify the clients. In another example, the service provider can sell an OC-n circuit, such as an OC-12 circuit, to a client, such as an end user, who can decide what signal type to use. For example, the signal type is STS 12c, STS3c, STS 1, or any combination of them. Certain embodiments of the present invention provide a mechanism that utilizes the SONET/SDH payload pointer H1/H2/H3 bytes as indicator for payload concatenation change, and take intelligent actions on the nodes within a service provider's network. Some embodiments of the present invention can eliminate or reduce manual notification from a client to its service provider about a pre-defined circuit signal type. For example, the adaptation process for optical circuit payload concatenation is automated. In another example, a service provider can offer optical circuits such as OC-n or STM-n without being concerned about its clients' payload concatenations. Certain embodiments of the present invention can eliminate or reduce the manual process of clients notifying their service provider when the clients need to change optical channel payload concatenations. Some embodiments of the present invention can monitor individual paths or components of a bundle of STSm's or VCm's. Certain embodiments of the present invention can provide summary alarms for a bundle of STSm's or VCm's. Some embodiments of the present invention are compliant with GR-1093 State Model.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing channel concatenations, the method comprising:
generating a plurality of STSm's associated with a plurality of network nodes, m being a positive integer, the plurality of STSm's being allocated for linking a first device and a second device through the plurality of network nodes;
setting the plurality of STSm's to a first plurality of states related to the plurality of network nodes, the plurality of network nodes including a first node and a second node;
determining whether a first valid signal is received from the first device by the first node, the first valid signal including information associated with a concatenation;
if the first valid signal is received from the first device by the first node,
processing information associated with the concatenation;
providing a first uni-directional cross-connect in a first direction associated with the first node based on at least information associated with the concatenation;
wherein the providing a first uni-directional cross-connect includes providing the concatenation to the plurality of STSm's in the first direction.

2. The method of claim 1 wherein m is equal to 1.

3. The method of claim 1 wherein the plurality of STSm's is bundled into an STSm-nB, n being the number of STSm's for the plurality of STSm's.

4. The method of claim 3 wherein n is selected from a group consisting of 1, 3, 12, 48, 192, and 768.

5. The method of claim 1 wherein the setting the plurality of STSm's to a first plurality of states comprises setting the plurality of STSm's to a first state for the first node.

6. The method of claim 5 wherein the first state is associated with Auto-InService.

7. The method of claim 1, and further comprising if the first valid signal is received from the first device by the first node, determining whether a uni-directional cross-connect in the first direction has been provided for each of the plurality of network nodes based on at least information associated with the concatenation.

8. The method of claim 7, and further comprising if a unidirectional cross-connect in the first direction is determined to have been provided for each of the plurality of network nodes, and if none of the plurality of network nodes is determined to have received a second valid signal from the second device, sending an AIS signal by at least one of the plurality of network nodes.

9. The method of claim 1, and further comprising:
determining whether a second valid signal is received from the second device by the second node, the second valid signal including information associated with the concatenation;
if the second valid signal is received from the second device by the second node,
processing information associated with the concatenation;
providing a second uni-directional cross-connect in a second direction associated with the second node based on at least information associated with the concatenation;
wherein the providing a second uni-directional cross-connect includes providing the concatenation to the plurality of STSm's in the second direction.

10. The method of claim 9 wherein the first node and the second node are different.

11. The method of claim 9 wherein the first node and the second node are the same.

12. The method of claim 9, and further comprising if the second valid signal is received from the second device by the second node, determining whether a uni-directional cross-connect in the second direction has been provided for each of the plurality of network nodes based on at least information associated with the concatenation.

13. The method of claim 9, and further comprising if a uni-directional cross-connect in the first direction and a uni-directional cross-connect in the second direction are determined to have been provided for each of the plurality of network nodes based on at least information associated with the concatenation, setting the plurality of STSm's to a second plurality of states for the plurality of network nodes respectively.

14. The method of claim 13 wherein each of the second plurality of states is associated with Auto-InService.

15. The method of claim 9 wherein the determining whether a first valid signal is received from the first device by the first node comprises:
determining whether the first device is connected to the first node;
determining whether a proper optical interface associated with the concatenation is provided to the first node by the first device.

16. A method for providing channel concatenations, the method comprising:
generating a plurality of STSm's associated with a plurality of network nodes, m being a positive integer, the plurality of STSm's being allocated for linking a first device and a second device through the plurality of network nodes;
setting the plurality of STSm's to a first plurality of states related to the plurality of network nodes, the plurality of network nodes including a first node and a second node;
determining whether a first valid signal is received from the first device by the first node, the first valid signal including information associated with a concatenation;
if the first valid signal is received from the first device by the first node,
determining whether the information associated with the concatenation is valid;
if the information associated with the concatenation is determined to be valid, providing a first unidirectional cross-connect in a first direction associated with the first node based on at least information associated with the concatenation;
wherein the providing a first uni-directional cross-connect includes providing the concatenation to the plurality of STSm's in the first direction.

17. The method of claim 16 wherein the determining whether the information associated with the concatenation is valid comprises:
receiving a plurality of frames, the plurality of frames being associated with a plurality of concatenations;
determining whether each of the plurality of concatenations is the same as the concatenation.

18. The method of claim 17 wherein the determining whether the information associated with the concatenation is valid further comprises if each of the plurality of concatenations is determined to be the same as the concatenation, determining the information associated with the concatenation to be valid.

19. The method of claim 17 wherein the plurality of frames comprises 5 frame.

20. A method for updating channel concatenations, the method comprising:
providing a plurality of network nodes associated with a plurality of STSm's, m being a positive integer, the plurality of STSm's being allocated for linking a first device and a second device through the plurality of network nodes and being concatenated based on at least information associated with a first concatenation for each of the plurality of network nodes in a first direction and a second direction;
receiving information associated with a second concatenation from the first device by a first node of the plurality of network nodes;
processing information associated with the second concatenation;
providing a first uni-directional cross-connect in the first direction associated with the first node based on at least information associated with the second concatenation;
wherein the providing a first uni-directional cross-connect includes providing the second concatenation to the plurality of STSm's in the first direction.

21. The method of claim 20 wherein m is equal to 1.

22. The method of claim 20 wherein the plurality of STSm's is bundled into an STSm-nB, n being the number of STSm's for the plurality of STSm's.

23. The method of claim 22 wherein n is selected from a group consisting of 1, 3, 12, 48, 192, and 768.

24. The method of claim 20, and further comprising determining whether a uni-directional cross-connect has been provided in the first direction for each of the plurality of network nodes based on at least information associated with the second concatenation.

25. The method of claim 20, and further comprising if none of the plurality of network nodes is determined to have received information associated with the second concatenation from the second device and the first concatenation and the second concatenation are different, sending a concatenation mismatch alarm by at least the first node.

26. A method for updating channel concatenations, the method comprising:
providing a plurality of network nodes associated with a plurality of STSm's, m being a positive integer, the plurality of STSm's being allocated for linking a first device and a second device through the plurality of network nodes and being concatenated based on at least information associated with a first concatenation for each of the plurality of network nodes in a first direction and a second direction;
receiving information associated with a second concatenation from the first device by a first node of the plurality of network nodes;
determining whether the information associated with the second concatenation is valid;
if the information associated with the second concatenation is determined to be valid, providing a first uni-directional cross-connect in the first direction associated with the first node based on at least information associated with the second concatenation;
wherein the providing a first uni-directional cross-connect includes providing the second concatenation to the plurality of STSm's in the first direction.

27. The method of claim 26 wherein the determining whether the information associated with the second concatenation is valid comprises:
receiving a plurality of frames, the plurality of frames being associated with a plurality of concatenations;
determining whether each of the plurality of concatenations is the same as the second concatenation.

28. The method of claim 27 wherein the determining whether the information associated with the second concatenation is valid further comprises if each of the plurality of concatenations is determined to be the same as the second concatenation, determining the information associated with the second concatenation to be valid.

29. The method of claim 27 wherein the plurality of frames comprises 5 frame.

30. A method for updating channel concatenations, the method comprising:
providing a plurality of network nodes associated with a plurality of STSm's, m being a positive integer, the plurality of STSm's being allocated for linking a first device and a second device through the plurality of network nodes and being concatenated based on at least information associated with a first concatenation for each of the plurality of network nodes in a first direction and a second direction;
receiving first information associated with a second concatenation from the first device by a first node of the plurality of network nodes;
receiving second information associated with the second concatenation from the second device by a second node of the plurality of network nodes;
processing the first information associated with the second concatenation;
processing the second information associated with the second concatenation;
providing a first uni-directional cross-connect in the first direction associated with the first node based on at least information associated with the second concatenation;
providing a second uni-directional cross-connect in the second direction associated with the second node based on at least information associated with the second concatenation;
wherein:
the providing a first unidirectional cross-connect includes providing the second concatenation to the plurality of STSm's in the first direction.
the providing a second uni-directional cross-connect includes providing the second concatenation to the plurality of STSm's in the second direction.

31. The method of claim 30 wherein the first node and the second node are different.

32. The method of claim 30 wherein the first node and the second node are the same.

33. The method of claim 30, and further comprising if the second valid signal is received from the second device by the second node, determining whether a uni-directional cross-connect in the second direction has been provided for each of the plurality of network nodes based on at least information associated with the concatenation.

34. The method of claim 30, and further comprising determining whether a uni-directional cross-connect has been provided in the second direction for each of the plurality of network nodes based on at least information associated with the second concatenation.

35. A method for updating channel concatenations, the method comprising:
providing a plurality of network nodes associated with a plurality of STSm's, m being a positive integer, the plurality of STSm's being allocated for linking a first device and a second device through the plurality of network nodes and being concatenated based on at least information associated with a first concatenation for each of the plurality of network nodes in a first direction and a second direction;
receiving first information associated with a second concatenation from the first device by a first node of the plurality of network nodes;
receiving second information associated with the second concatenation from the second device by a second node of the plurality of network nodes;
determining whether the first information associated with the second concatenation is valid;
determining whether the second information associated with the second concatenation is valid;
if the first information associated with the second concatenation is determined to be valid, providing a first uni-directional cross-connect in the first direction associated with the first node based on at least information associated with the second concatenation;
if the second information associated with the second concatenation is determined to be valid, providing a second uni-directional cross-connect in the second direction associated with the second node based on at least information associated with the second concatenation;
wherein:
the providing a first uni-directional cross-connect includes providing the second concatenation to the plurality of STSm's in the first direction;
the providing a second unidirectional cross-connect includes providing the second concatenation to the plurality of STSm's in the second direction.

36. The method of claim 35 wherein the determining whether the second information associated with the second concatenation is valid comprises:
receiving a plurality of frames, the plurality of frames being associated with a plurality of concatenations;
determining whether each of the plurality of concatenations is the same as the second concatenation.

37. The method of claim 35 wherein the determining whether the second information associated with the second concatenation is valid further comprises if each of the plurality of concatenations is determined to be the same as the second concatenation, determining the second information associated with the second concatenation to be valid.

38. The method of claim 35 wherein the plurality of frames comprises 5 frame.
